(19) United States
(12) Patent Application Publication
(10) Pub. No.: US 2012/0050929 A1
(43) Pub. Date: Mar. 1, 2012

(54) METHOD FOR FEEDING A MULTIPHASE ELECTRIC NETWORK AND ASSOCIATED CIRCUIT ARRANGEMENT

(75) Inventor: Matthias Bartsch, Bremen (DE)

(73) Assignee: POWERWIND GMBH, Hamburg (DE)

(21) Appl. No.: 13/148,651

(22) PCT Filed: Feb. 9, 2009
(86) PCT No.: PCT/EP09/00887

§ 371 Date: Nov. 14, 2011

(51) Int. Cl. H02H 3/00

(52) U.S. Cl. 361/62

(57) ABSTRACT

According to embodiments of the invention, a method is provided for the feeding of a multiphase electric network by means of an electric generator of a regenerative energy source that is connected to the network through an inverter. In the event of the occurrence of a non-symmetrical network fault, the feed to the phases that are not affected by the fault is interrupted and a current effecting voltage back-up voltage is fed to the affected phases.

The invention refers to a method for the feeding of a multiphase electric network from a controlled inverter of an electric generator of a regenerative energy source, as well as the circuit configuration that is appropriate for it.

With the increase in the proportion of regenerative energy, for example from wind power plants, to the feeding of the public energy distribution network, the network operators are calling for the regenerative energy sources to contribute to the back-up of the network in the case of a network fault. Insofar as the network fault does not impact all phases of the network in an equal amount, for example in the event of two-pole fault of a three phase network, then it is generally only the voltage of the affected phases that collapses, and a dissymmetry of the voltage between the affected and not affected phases occurs.

The invention lies in the task of indicating a method and an appropriate circuit configuration, with which the network can be backed up in the event of non-symmetrical network faults.

As regards the method, this task is solved according to the invention insofar as, when there is a non-symmetrical network fault that affects only a part of the phases, the feeding to the non-affected phases is then zeroed out in a controlled manner.

In the case of the invention, there is an energy source, which under non-disrupted symmetrical operation of the network feeds all phases in a reasonably equal measure, upon the occurrence of a non-symmetrical network fault; it is employed to feed the deficient phases, whereas no input is fed to the phases that are not affected by the fault. The energy fed by a regenerative energy source is thereby used for the back-up of the network that is impacted by a non-symmetrical network fault in an especially efficient manner. This type of back-up voltage is also free of the danger of excess voltage to the on affected phases.

In a preferred embodiment, it is foreseen that the amplitude of the current feed for at least one of the phases that are affected by a network fault is regulated to reach a set value that is greater than that during fault-free operation, and/or that, for at least one of the phases affected by the network fault, the feed is regulated so that it goes into reactive current feed. The latter is especially achieved by having the phase angle between the current feed and the voltage of the affected phase be regulated to a value that nears or is equal to 90°. This reactive current feed, especially with increased current amplitude, leads to the greatest possible increase of the voltage to the phases affected by the fault. Nothing stands in the way of the feed to the phases that are not affected by the fault being zeroed out during the period of the fault, insofar as these non-affected phases are fed by the remaining feed points that are distributed throughout the network.

In a preferred embodiment, it is foreseen that the occurrence of a network fault is registered through surveillance of the voltage of the phases. The switchover to the non symmetrical feed, as per the invention, can, for example, take place when the ascertained voltage of the affected phase drops below a preset threshold, for example below a voltage that is equivalent to 85% of the value of the nominal voltage that is foreseen for the fault-free operation of the network.

A circuit configuration that is appropriate for the carrying out of the method according to the invention with a controlled inverter of an electrical generator of a regenerative energy source that is hooked up to a multiphase electrical network, that can be controlled through the inverter for the feeding of the network, is characterized according to the invention insofar as the control device is capable of ascertaining the occurrence of a network fault for every phase, as well as regulating that the feed for the phases that are ascertained as not being faulty is zeroed out.

The inverter of this circuit configuration according to the invention preferably exhibits an intermediate circuit that is fed by an inverter that is on the generator side and a network side inverter that is fed by the intermediate circuit. Preferably this inverter on the network side exhibits the inverter half bridge that is connected to the intermediate circuit for each phase of the network, for example by means of two insulated gate bipolar transistors (IGBT) which are in series and regulated by the control device. The output phases of this half bridge are preferably connected to the network by means of a star-triangle transformer. The non-symmetrical power feed in the event of a fault can for example be deviated through a return conductor which connects the intermediate circuit with the neutral point of this transformer. This return conductor can furthermore be grounded. Alternatively it is also possible to dispense with such a return conductor, in which case the neutral point of the transformer and the intermediate circuit should each be individually grounded.

A particularly important area of application of the method according to the invention and of the circuit configuration according to the invention is the network feed by wind power plants, in particular the feeding of three-phase networks.

Further features and details of the invention are revealed from the following description, in which the invention is expounded upon through the example of the drawing. Herein are shown:

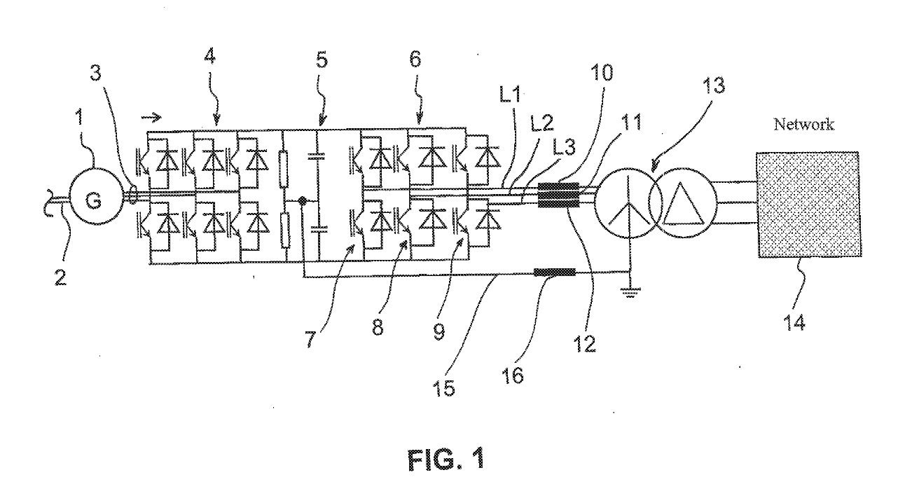

FIG. 1 a first embodiment of a circuit configuration according to the invention, and

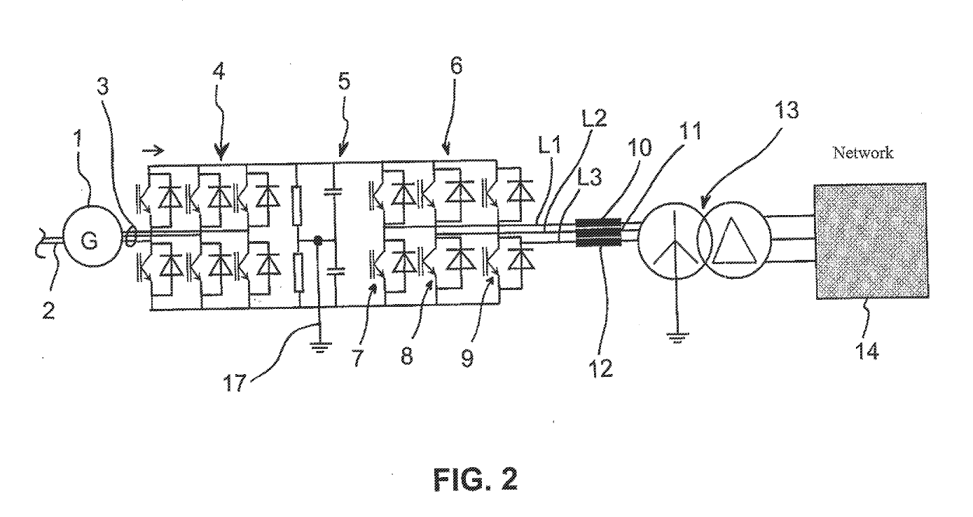

FIG. 2 a second embodiment of the circuit configuration according to the invention.

FIG. 1 shows a three-phase generator (three phase asynchronous generator or three phase synchronous generator) 1, whose driveshaft 2 is driven by a wind turbine that is not represented in the drawing. In this case, there is a generator-side inverter 4, where we are dealing with a six pole three phase IGBT inverter that is connected to the three outer cables 3 of the three-phase generator. The IGBT inverter feeds an intermediate direct current circuit 5 to which it is connected.

A network-side inverter 6 is connected to the intermediate direct current circuit 5, that exhibits three parallel switched IGBT half bridges 7, 8, and 9, each of which delivering one of the three phases L1, L2 and L3 at their output for feeding of a three-phase network. The phases L1, L2 and L3 are connected by way of the network connection flow controls 10, 11 and 12 to the under voltage side of a star-triangle transformer 13, whose overvoltage side is connected to the three-phase network 14. An intermediate tapping of the intermediate direct current circuit 5 is joined with the star-triangle transformer 13 by way of a neutral conductor 15 and a network connection flow control 16. The neutral conductor is furthermore grounded.

A control device (not shown) regulates the IGBT's of the generator side inverter 4 in such a manner that the three-phase current that is delivered by the generator 1 is aligned for the feeding of the intermediate direct current circuit 5. Furthermore, in the absence of network faults, this control device regulates the IGBT's of the network side inverter 6 in such a manner that its output phases L1, L2 and L3 feed the under voltage side of the star-triangle transformer with three-phase current.

Upon the occurrence of a non-symmetrical network fault, the network voltage collapses in one or two phases. The control device ascertains this collapse in the voltage and accordingly zeroes out the feed of the not affected phase or alternatively both of the not affected phases. On the other hand, for the affected phase or alternatively the two affected phases, the respective amplitude threshold of the current being fed in is increased and its phase is adjusted to a value in relation to the voltage, which, where possible, lies near to 90°. The voltage is hereby increased as much as is possible in the affected phases.

In the embodiment represented in FIG. 1, the non-symmetrical current feed of the non-symmetrical network fault is discharged through the neutral point of the star-triangle transformer 13 and the neutral conductor 15 that is reduced by the intermediate direct current circuit 5. The neutral point is furthermore grounded. The embodiment represented in FIG. 2 differs only in the absence of the Neutral conductor 15 which is replaced by a grounding 17 of the intermediate tapping of the intermediate direct current circuit 5. In this embodiment, the deviation of the current feed only takes place through its potential. The corresponding parts are indicated with the same reference numbers in both FIG. 1 and FIG. 2, and the relative description of FIG. 1 therefore equally holds true for FIG. 2.

### Index of the References

1 Three-phase generator
2 Drive shaft
3 Outer cable
4 Generator side inverter
5 Intermediate direct current circuit
5 Network side inverter
7, 8, 9 IGBT-half bridge
10, 11, 12 Network connection flow controls
13 Star-triangle transformer
14 Network
15 Neutral conductor
16 Network connection flow control
17 Ground

1. A method for the feeding of a multiphase electric network from a controlled inverter of an electric generator of a regenerative energy source, which is characterized in the presence of non-symmetrical network fault, where only one part of the phases is affected, by the feeding for the non-affected phases being zeroed out.

2. A method according to claim 1, wherein the amplitude of the feed current of at least one of the phases affected by the network fault is regulated to an increased threshold when compared to the fault-free operation of the network.

3. A method according to claim 1, wherein the feeding is switched to reactive current feeding for at least one of the phases that is affected by the network fault.

4. A method according to claim 3, wherein the phase angle between the feed current and the voltage is regulated to a value that nears or is equal to 90° for the affected phase.

5. A method according to claim 1, wherein the occurrence of a network fault is ascertained by surveillance of the phase voltages.

6. A method according to claim 1, wherein the network being is a three-phase network.

7. A method according to claim 1, wherein the regenerative energy source is wind power plant.

8. A circuit configuration with a controllable inverter of an electrical generator of a regenerative energy source that is hooked up to a multiphase electrical network and a control device through which the inverter can be controlled for the feeding of the network, which is characterized by the control device being capable of ascertaining the occurrence of a network fault for every phase, as well as regulating that the feed for the phases that are ascertained as not being faulty can be zeroed out.

9. A circuit configuration according to claim 8, wherein the inverter exhibits an intermediate circuit that is fed by a inverter that is on the generator side and a network side inverter that is fed by the intermediate circuit that is controlled by the control device.

10. A circuit configuration according to claim 9, wherein the network side inverter is connected to the network through a star-triangle transformer.

11. A circuit configuration according to claim 10, wherein the neutral point and the intermediate circuit are grounded.

12. A circuit configuration according to claim 10, wherein the neutral point and the intermediate circuit are joined together through a return conductor.

13. A circuit configuration according to claim 8, wherein the regenerative energy source is a wind power plant.

14. A circuit configuration according to claim 8, wherein the network is a three-phase network.

15. A circuit configuration according to claim 8, wherein the generator is a three-phase generator.
